(19) United States
(12) Patent Application Publication
(10) Pub. No.: US 2014/0319056 A1
(43) Pub. Date: Oct. 30, 2014

(54) PROCESS FOR MANUFACTURING POTABLE WATER AND APPARATUS THEREFOR

(71) Applicant: JFE ENGINEERING CORPORATION, Tokyo (JP)

(72) Inventors: Koji Fuchigami, Tokyo (JP); Takeshi Mizukami, Tokyo (JP); Makoto Kunugi, Tokyo (JP); Norihito Uetake, Tokyo (JP); Takeshi Uchiyama, Tokyo (JP); Yohei Tomida, Tokyo (JP)

(21) Appl. No.: 14/355,050

(22) PCT Filed: Oct. 31, 2012
(86) PCT No.: PCT/JP2012/006970

§ 371 Date: Apr. 29, 2014

(30) Foreign Application Priority Data
Oct. 31, 2011 (JP) 2011-238284
Apr. 2, 2012 (JP) 2012-083918
Apr. 6, 2012 (JP) 2012-086981
Apr. 11, 2012 (JP) 2012-089816
May 28, 2012 (JP) 2012-120403

(51) Int. Cl. B01D 65/02; B01D 63/02; C02F 1/44; B01D 61/00

(52) U.S. Cl. CPC B01D 65/02; B01D 61/002; B01D 63/02; C02F 1/445
USPC 210/648; 210/177

(57) ABSTRACT

It is to provide a process for manufacturing potable water from a liquid to be treated, such as seawater by using forward osmosis membrane, wherein the solution after the separation of water from dilute draw solution diluted by the migration of water from the liquid to be treated, is stably regenerated and reutilized and an apparatus therefor, and the process and apparatus are a process for manufacturing potable water which comprises, a forward osmosis step wherein a liquid of which solvent is water is allowed to contact with a draw solution produced by dissolving a prescribed amount of a volatile material in water through a semi-permeable membrane, and water in said liquid is allowed to migrate to said draw solution through said semi-permeable membrane, a distillation step wherein a dilute draw solution having been diluted with water which was produced in said step is adjusted to a prescribed temperature, and then is delivered to a distillation column where gas comprising the volatile material and water vapor is discharged from the top of the column and potable water is discharged from the bottom of the column, and a cooling • regeneration step wherein said draw solution is regenerated by cooling said gas and an apparatus therefor.

### TECHNICAL FIELD

This invention relates to a process for manufacturing potable water by purifying, such as seawater or brackish water using semi-permeable membrane and an apparatus therefor.

### BACKGROUND ART

Although various methods are known for purifying seawater using semi-permeable membrane, most of the methods which have been developed are reverse osmosis where a pressure higher than the osmotic pressure is applied to seawater to force permeation of water. The methods have a problem requiring cost for equipments and operation due to the necessity for presuriging to a high pressure. Whereas, when a salt solution having a concentration higher than seawater is being present through semi-permeable membrane, water can migrate to the salt solution by the osmotic pressure without pressuriging. When a solution containing volatile gas dissolved therein is used as the salt solution, the volatile gas can be evaporated to be separated by distilling the salt solution to obtain potable water. This method has already been developed using a combination of ammonia and carbon dioxide as the volatile gas (Patent Documents 1, 2).

In the method of Patent Document 1, as shown in FIG. 12, seawater 2 is supplied to the first chamber 58 of the semi-permeable membrane apparatus, and a high concentration salt solution 6 produced by dissolving ammonia and carbon dioxide in water is supplied to the second chamber 59 provided on the opposite side through the semi-permeable membrane 4. Water in the seawater 2 passes through the semi-permeable membrane to enter into the salt solution 6 to make it a dilute salt solution 7, and is delivered to the third chamber 57. Ammonium hydrogen carbonate is precipitated there by cooling with blowing carbon dioxide. The supernatant is delivered to a distillation column 11, and is distilled to separate portable water 12, a mixed gas 10 containing ammonia and carbon dioxide and water is separated from the top of the column, and is returned to the second chamber 59. While, the precipitates separated in the third chamber 57 are dissolved by adding a salt solution, and the produced high concentration salt solution 6 is also returned to the second chamber 59.

In the method of Patent Document 2, a salt solution produced by dissolving ammonia and carbon dioxide in water is supplied to opposite side to seawater through a semi-permeable membrane to allow water in the seawater to migrate to the salt solution by passing through the semi-permeable membrane. The dilute salt solution thus produced is treated with an ion-exchange membrane or a distillation column or the like to separate ammonium ions and carbonate ions individually to obtain potable water. The separated ammonium ions and carbonate ions are dissolved and returned to the original chamber of the semi-permeable membrane.

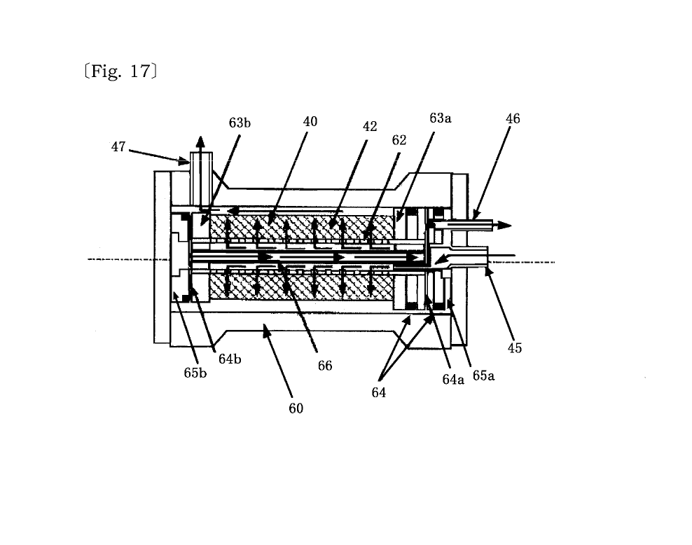

For the semi-permeable membrane apparatus, a hollow fiber membrane module is used. An example of a conventional hollow fiber membrane module is shown in FIG. 17. This hollow fiber membrane module is shown in FIG. 1 of Patent Document 3, and one hollow fiber membrane element 40 is contained in a cylindrical pressure vessel 60. The hollow fiber membrane element 40 is composed of hollow fiber membranes 42 arranged so as to cross each other surrounding a feed fluid dispensing pipe 62, and both ends are fixed by resin 63a, 63b. Apertures 64a, 64b of the hollow fiber membranes are formed on both sides, and respective apertures 64a, 64b are provided with a permeated fluid collecting member 65a, 65b. Permeated fluid is collected there, and permeated fluid at one end is collected to the other permeated fluid collecting member 65a through an inner pipe 66. The pressure vessel 60 is provided with a feed fluid inlet 45, a concentrated fluid outlet 47 and a permeated fluid outlet 46.

Feed fluid enters from the feed fluid inlet 45, and is supplied toward the outside in circumferential direction to the hollow fiber membranes 42 while passing through the feed fluid dispensing pipe 62. A part of the fluid permeates the hollow fiber membrane 42, and enters from the aperture 64a, 64b of the hollow fiber membrane, passes through the permeated fluid collecting members 65a, 65b and the inner pipe 66, and is taken out as the permeated fluid from the permeated fluid outlet 46. The concentrated fluid not permeated the hollow fiber membrane 42 passes the flow path between the hollow fiber membrane element 40 and the pressure vessel 60, and is taken out as the concentrated fluid from the concentrated fluid outlet 47. The concentrated fluid is sealed with an O-ring 64, and therefore, does not mix with the permeated fluid.

Besides, an apparatus is also known to render seawater potable utilizing solar heat. An apparatus therefor is, for example, described in Patent Document 4. In the apparatus, seawater is heated in a solar pond, and evaporated by flash evaporation. The water vapor is condensed to produce potable water.

An apparatus for manufacturing potable water utilizing solar heat and semi-permeable membrane is also known (Patent Document 5). The apparatus is, as shown in FIG. 14, structured by a reflector portion 71 which reflects sunlight, a heat collecting portion 72 which receives the heat of reflected sunlight to heat a mineral oil or molten salt supplied to the inside, a steam generator (evaporating portion) 73 which evaporates water using the mineral oil or molten salt heated in the heat collecting portion 72 as a heat source, a steam turbine (turbine portion) 74 driven by the evaporated steam, a generator (electricity generating portion) 75 which is driven by the steam turbine 74 to generate electricity, a reverse osmosis potable water manufacturing apparatus (potable water producing portion) 76 which manufactures potable water from saline solution, a multi-effect potable water manufacturing apparatus (potable water producing portion) 77 which manufactures potable water utilizing waste heat of the steam which has driven the steam turbine 74, and a combustion furnace (combustion portion) 78 which burns biomass, such as date palm or wheat.

As the techniques to manufacture potable water from seawater or discharged water, there are known the evaporation process where these water is heated to evaporate under reduced pressure, and then condensed to obtain potable water, and the reverse osmosis where reverse osmosis membrane is used, and potable water is obtained by applying twice or more the osmotic pressure of seawater to the reverse osmosis membrane, and thereby permeating only water without salt contents. Moreover, a system which combines these two techniques is known capable of a dressing the balance between the demand for potable water and the demand for electric power.

For example, Patent Document 6 discloses a method of manufacturing potable water by multi-flash evaporation system of seawater, wherein discharged seawater of which temperature has been elevated in the heat refusal portion is introduced into a reverse osmosis system to produce more potable water, in order to improve the yield of potable water from seawater.

In addition, Patent Document 7 discloses a technique in a potable water manufacture system from seawater using reverse osmosis membrane, which uses an electricity generation equipment utilizing the temperature of seawater as cooling source by heat exchange, and pressurizing the seawater of which temperature has been raised by the heat exchange to produce potable water through the reverse osmosis membrane. A method of using a steam turbine in the electricity generation equipment is also disclosed.

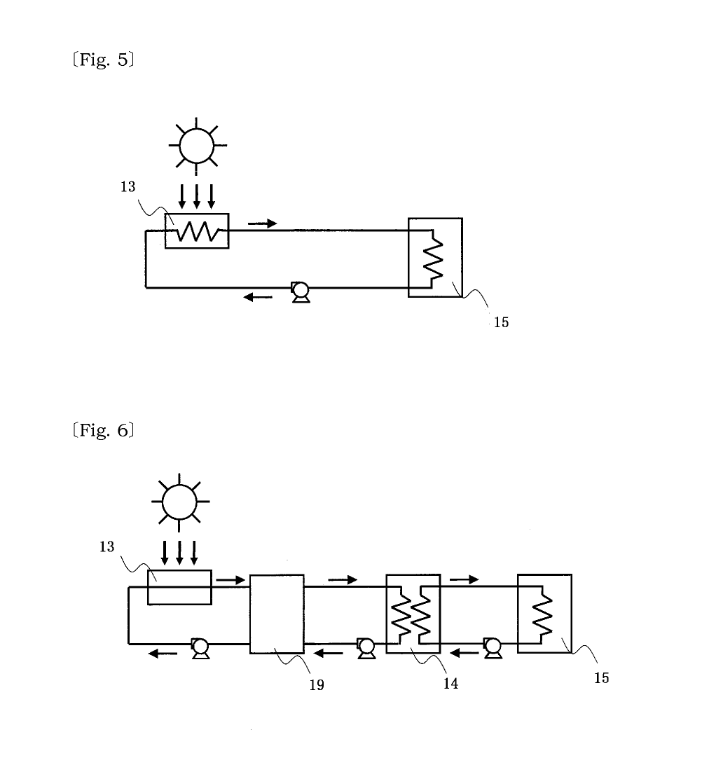

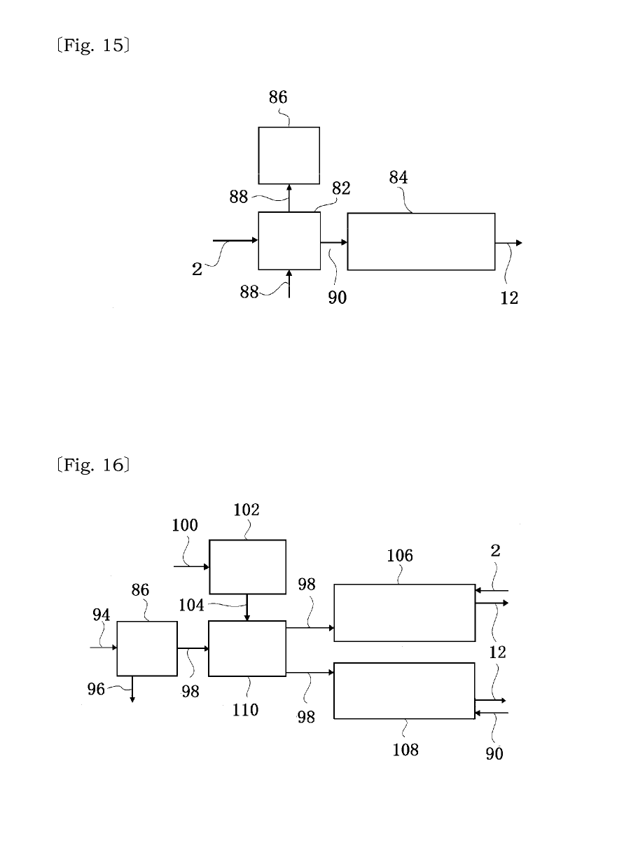

The system disclosed in FIG. 5 of Patent Document 7 is shown in FIG. 15 and FIG. 16.

In this system, as shown in FIG. 15, seawater 2 enters into a heat exchanger 82, and warmed by the heat exchange with a medium 88. The warmed seawater 90 is delivered to a potable water production equipment 84 from seawater, and potable water 12 is taken out there. While, the cooled medium 88 is delivered to a electricity generation equipment 86. As the potable water production equipment, a combination of a potable water production equipment 106 from seawater by the evaporation process and a potable water production equipment 108 from seawater by the reverse osmosis process is shown in FIG. 16. The warmed seawater 90 enters from the lower right side in the figure into the potable water production equipment 108 from seawater by the reverse osmosis, and potable water 12 is taken out. While, fuel 94 is supplied to the electricity generation equipment 86 located on the left side in the figure, and power supply 96 is taken out therefrom. The exhaust heat 98 of this electricity generation equipment 86 is distributed in an exhaust heat distribution equipment 110, and delivered to the potable water production equipment 106 from seawater by the evaporation process and to the potable water production equipment 108 from seawater by the reverse osmosis process. The distribution of the exhaust is conducted by the calculation in a distribution amount operation portion 102 based on the information on the demand for potable water, and the distribution instruction information 104 is communicated to the exhaust heat distribution equipment 110.

On mining shale gas, oil sand, CBM (coal bed methane), petroleum or the like, an aqueous agent solution is sometimes injected as water or steam for digging for the purpose of improving output of natural gas or crude oil. As a result, crude oil taken out from oil stratum contains the aqueous agent solution and underground water containing inorganic ions in the stratum as accompanied water, and the accompanied water is separated from the mined natural gas or crude oil. Since the separated accompanied water contains salt content, organic materials, suspensoids and the like, when it is discharged as is, a problem of environmental pollution occurs. Therefore, purification of the water is necessary.

A purification technique of the accompanied water was developed which conducts sand filtration and activated carbon treatment to remove suspensoids and organic materials, and then discharged to sea with leaving salt content (Patent Document 8).

A technique of utilizing membrane separation is also known (Patent Document 9). In the method, water-soluble silica contained in the accompanied water is converted to insoluble silica, and remove it by ceramic membrane. Subsequently, water content is evaporated to recover it by an evaporator, and is reused for mining crude oil. It is also disclosed to use reverse osmosis membrane instead of the evaporation.

### PRIOR ART DOCUMENTS

### Patent Documents

Patent Document 1: U.S. Patent Application Publication No. 2005/0145568 A1
Patent Document 2: JP 2011-83663 A
Patent Document 3: JP 2003-290632 A
Patent Document 4: JP 2-214586 A
Patent Document 5: JP 2006-341165 A
Patent Document 6: JP 60-172393 A
Patent Document 7: JP 2011-177600 A
Patent Document 8: JP 2004-275884 A
Patent Document 9: U.S. Patent Application Publication No. 2011/0168629 A1 (p 3, FIG. 3)

### SUMMARY OF THE INVENTION

### Problems to be Solved by the Invention

As shown in Patent Document 1, to mix the total amount of the aqueous solution containing diluted ammonium carbonate with the total amount of the gas composed of carbon dioxide, ammonia and water separated and discharged from the distillation column results in the elevation of the concentration of carbon dioxide and ammonia in the aqueous solution containing ammonium carbonate for taking out water entered in the distillation column. When these concentrations elevate, energy necessary for taking out water increases.

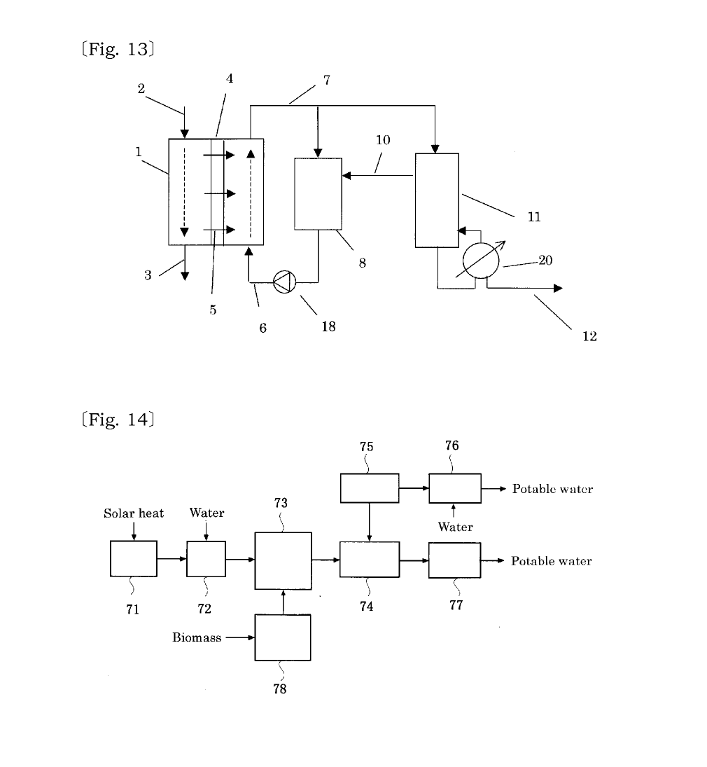

As shown in Patent Document 2, to mix a part of the aqueous solution containing diluted ammonium carbonate with separated gas (FIG. 13) results in the reduction of taking out volume of water, compared with the case that when the total amount of the aqueous solution containing diluted ammonium carbonate is distilled, a large quantity of water can be taken out. Moreover, power is required for circulating the part of the aqueous solution, and pipes for circulating the part of the aqueous solution are needed to complicate the plant facilities.

Therefore, it is needed to deliver the total amount of the aqueous solution containing diluted ammonium carbonate to a distillation column, to reduce energy necessary for distillation, to take out more water, and to decrease power and pipes to render the plant facilities compact.

Incidentally, different from the system that uses hydrometeological pressure as driving force for filtration, such as reverse osmosis (RO), in the case that forward osmosis (FO) process is employed which uses osmotic pressure difference between both sides of solutions interposing a semi-permeable membrane as a driving force for filtration, when liquid flow speed in the vicinity of membrane surface (membrane surface flow speed) is small, concentration or dilution occurs in the vicinity of membrane surface. As a result, available difference of osmotic pressure decreases to render filtration rate small. In the case that the semi-permeable membrane is hollow fiber shaped, membrane surface flow speed can be easily raised on the inside of hollow fiber due to narrow flow path. However, on the outside of hollow fiber, since flow path is broad, to raise the membrane surface flow speed increases flow volume to increase energy for the delivery of liquid. Otherwise, filtration speed lowers by channeling or short circuit.

The system of Patent Document 4 has a problem of low efficiency in collection of heat, and not suitable for the manufacture of a large quantity of potable water.

The system of Patent Document 5 is a system of converting solar heat to electricity through a heat engine, and therefore, loss in conversion of energy generates. Efficiency in electricity generation is, in general, low, when received solar heat is set 1, the efficiency is about 0.1-0.2.

The evaporation process of Patent Document 6 and Patent Document 7 requires a lot of thermal energy for the evaporation of raw water, and the reverse osmosis membrane process requires a great electricity power due to the use of a high pressure pump. Therefore, the technique consumes a lot of energy, and the system can not utilize the exhaust energy of one process to the other. It is desired to develop a system utilizing energy more efficiently.

The technique of Patent Document 9 utilizing membrane separation is excellent in the reuse of accompanied water by purification. However, the reverse osmosis membrane treatment is conducted at a high pressure of about 6-8 MPa that requires a great electric power. Moreover, concentrates left without permeated generates in a large quantity, i.e. about a half of accompanied water, and energy is required for the evapolation of the concentrates.

The present invention has been made in order to solve the above problems, and the object is to reuse the gas composed of carbon dioxide, ammonia and water, which was separated from an aqueous solution containing diluted ammonium carbonate by distillation, by cooling as it is to render a state of aqueous solution.

Another object of the invention is to provide a means for separating potable water by distilling the diluted draw solution efficiently.

Another object of the invention is to provide a system capable of utilizing energy efficiently by combining the evaporation process and the forward osmosis process.

Another object of the invention is to provide a method of treating accompanied water with less electric power and energy to reuse it.

Another object of the invention is to provide a hollow fiber membrane module exhibiting good filtration rate when a semi-permeable membrane is used in the forward osmosis process.

### Means for Solving Problems

The present invention has been made in order to achieve the above objects, and provides a process for manufacturing potable water which comprises a forward osmosis step wherein a liquid of which solvent is water is allowed to contact with a draw solution produced by dissolving a prescribed a amount of a volatile material in water through a semi-permeable membrane, and water in the above liquid is allowed to migrate to the above draw solution through the above semi-permeable membrane, a distillation step wherein a dilute draw solution having been diluted with water which was produced in the above step is adjusted to a prescribed temperature, and then is delivered to a distillation column where gas comprising the volatile material and water vapor is discharged from the top of the column and potable water is discharged from the bottom of the column, and a cooling regeneration step wherein the above draw solution is regenerated by cooling the above gas, and an apparatus therefor.

The invention is also characterized by utilizing solar heat without converting to electricity as a heat source for distilling the dilute draw solution.

Thus, the invention provides, in the above manufacturing process of potable water and the apparatus therefor, a process for manufacturing potable water characterized by using water vapor manufactured by utilizing condensed solar energy as a heat source for the dilute draw solution in the above distillation step, and an apparatus therefor.

The invention was noted that, in the forward osmosis process, heat of the potable water (temperature: 60-70° C.) manufactured by the evaporation process can be utilized as a heat source for the distillation of dilute draw solution to separate the volatile solute and potable water, and devised a novel means for manufacturing potable water by a combination of the evaporation process and the forward osmosis process.

Thus, the present invention provides a process for manufacturing potable water which has further an apparatus for manufacturing potable water from a liquid of which solvent is water by the evaporation process, and sensible heat of the potable water manufactured by the above evaporation method potable water manufacturing apparatus is utilized as a heat source of the dilute draw solution in the above distillation process, and an apparatus therefor.

The invention is also characterized by saving the electric power required for pressurizing at a high pressure by conducting production of potable water from the filtrate obtained by filtration of accompanied water discharged from wells by the forward osmosis membrane treatment instead of the reverse osmosis membrane treatment, and by saving the total quantity of electricity and energy required for the treatment of accompanied water by utilizing the heat generated by the evaporation of membrane concentrates produced in the membrane treatment and the heat of condensates produced in the after crystallization step, for the heat source for heating the dilute draw solution necessitated by converting to the forward osmosis membrane treatment.

Thus, the invention provides a process for manufacturing potable water, wherein the liquid of which solvent is water is a filtrate of the accompanied water discharged from wells obtained by filtration in the filtration treatment step, and has an evaporation step wherein the membrane concentrates which are left after the migration of water in the above liquid to the draw solution through the semi-permeable membrane are concentrated by evaporation to obtain evaporation concentrates and condensed water, and a crystallization step wherein the above evaporation concentrates are further concentrated by evaporation to deposit salts in the evaporation concentrates and to obtain condensate water, and an apparatus therefor.

The invention is also characterized by a hollow fiber membrane module used as the semi-permeable membrane apparatus by providing a partition in the space between the bundle of hollow fiber membranes and the casing containing it, and thereby turning the flow of the second fluid flowing the space to the direction crossing the bundle of the hollow fiber membranes to deliver the flow into the bundle. As a result, the second fluid is mixed in the casing to inhibit lowering of filtration rate.

Thus, the invention provides a potable water manufacturing apparatus, wherein the above semi-permeable membrane is hollow fiber membrane, and the semi-permeable membrane apparatus equipped with it is a hollow fiber membrane module containing a bundle of a number of hollow fiber membranes of which both ends are opened in a casing. The casing has an inlet port of a first fluid flowing on the inside of the above hollow fiber membrane and an outlet port of a second fluid flowing on the outside of the hollow fiber membrane at one end of the casing, and an outlet port of the first fluid flowing on the inside of the hollow fiber membrane and an inlet port of the second fluid flowing on the outside of the hollow fiber membrane at the other end of the casing. The module has partitions which inhibit short circuit of the second fluid in the space between the inner wall of the casing and the outer periphery of the bundle of the hollow fiber membranes.

In the FO process, the concentration in the vicinity of membrane surface comes close to the concentration of the main flow (bulk) by ensuring membrane surface flow speed at a definite value or more or improving mixed conditions as to the liquid on both sides of the membrane, and filtration rate is raised. That is, in the FO process, it is ideal that liquid flows on both sides of membrane are plug flow (piston flow) without channeling on short circuit.

In this hollow fiber module, by setting partitions on the outside of the bundle of hollow fiber membranes, channeling • short circuit are inhibited to accelerated mixing, and the outside flow of hollow fiber membrane brings close to plug flow, and high filtration rate is made possible.

### Effects of the Invention

According to the invention, by cooling the gas composed of carbon dioxide, ammonia and water separated from the dilute draw solution by distillation as it is into aqueous solution state, the draw solution is regenerated and reused. Thereby, energy necessary for distillation can be saved. Moreover, more water can be taken out, and power and pipes can be saved to render the structure compact.

In the invention, solar energy is used as heat source, and thereby, losses generated in conversion to electricity can be removed to improve utilization efficiency of solar energy. Therefore, space for installation of solar heat collector and cost can be saved compared with the use of reverse osmosis membrane apparatus.

Moreover, by cooling the gas composed of volatile material and water separated from the dilute draw solution by distillation as it is into aqueous solution state, the draw solution is regenerated and reused. Thereby, energy necessary for distillation can be saved. Moreover, more water can be taken out, and power and pipes can be saved to render the structure compact.

In addition, the concentration of draw solution can be thickened or thinned by a simple method, and efficient operation of apparatus becomes possible.

In the invention, by combining the evaporation process and the forward osmosis process, heat of potable water manufactured in the evaporation process can be utilized for the separation of volatile solute and potable water from the dilute draw solution by distillation. Therefore, energy is utilized efficiently to decrease manufacturing cost of potable water. Accordingly, by adding the FO process plant to an existing evaporation process plant, production of water can be increased with low cost.

In the invention, accompanied water discharged from wells can be treated with less electric power and energy, and treated water can be reused as water or steam for digging.

By using the hollow fiber membrane module of the invention, even when the filtration using hollow fiber membrane is in the forward osmosis, a high filtration rate can be maintained.

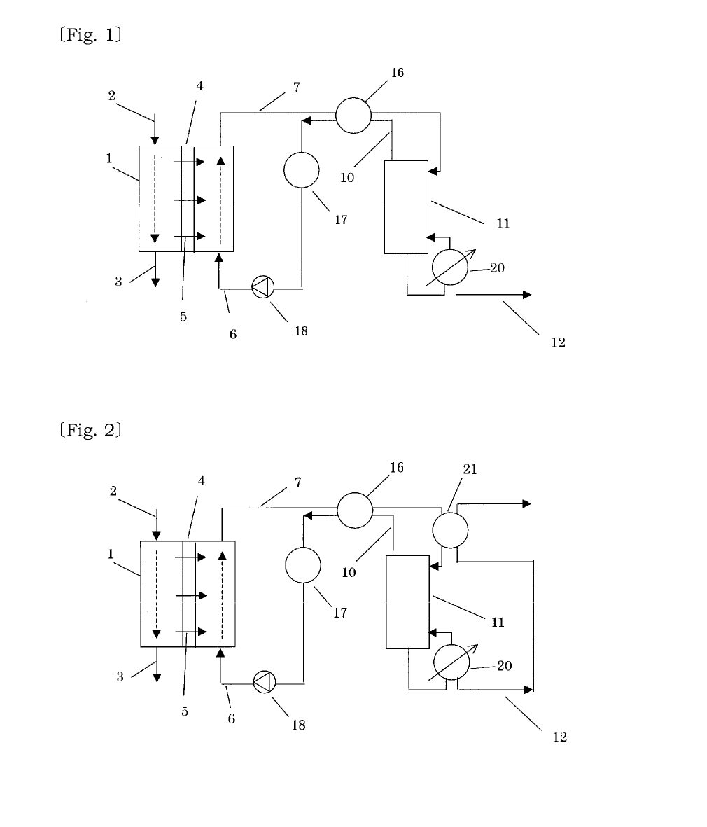

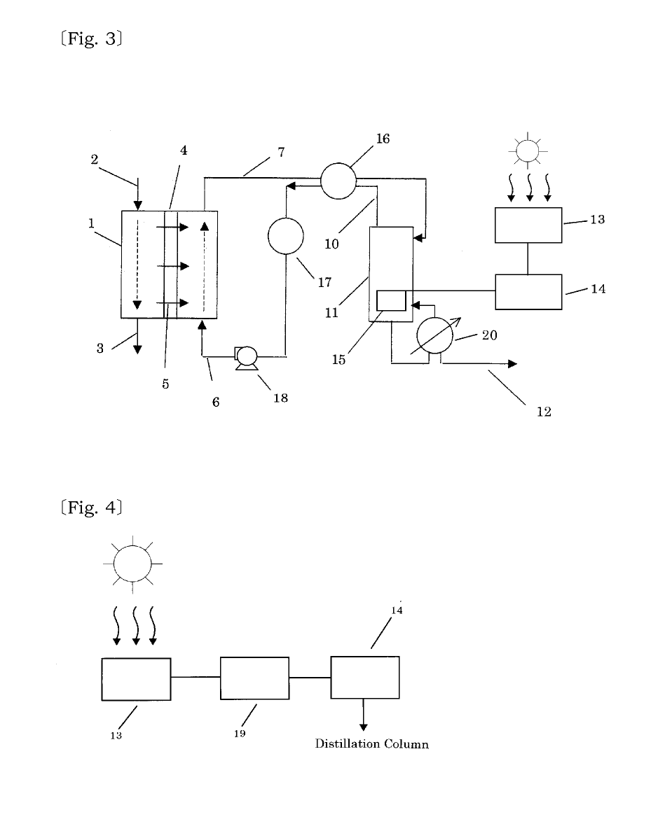

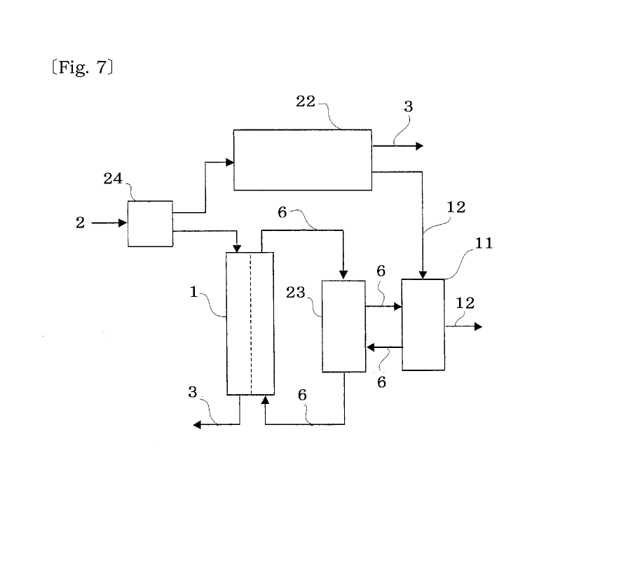

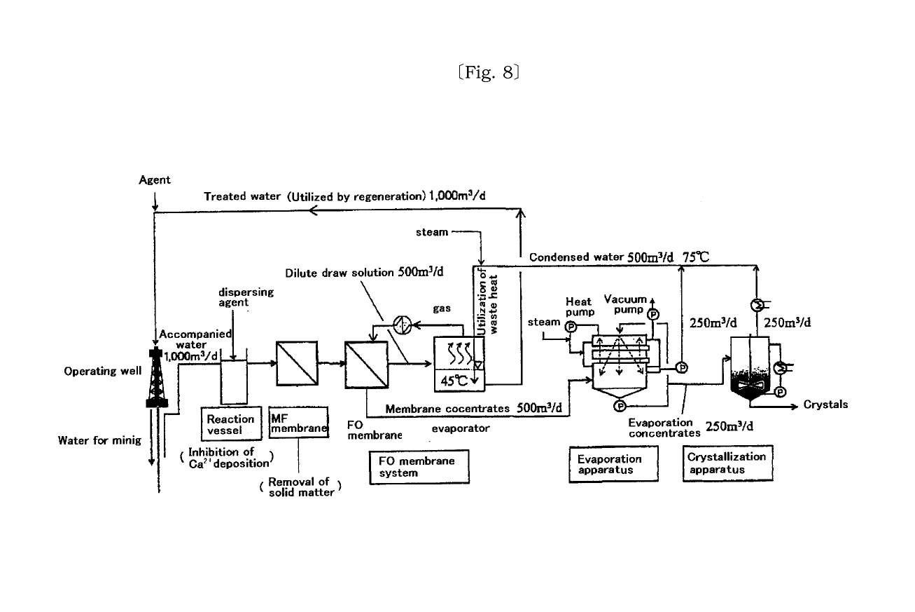

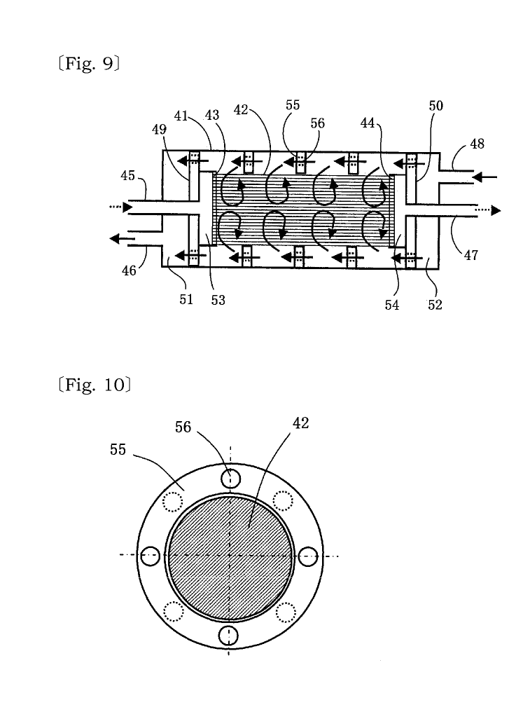

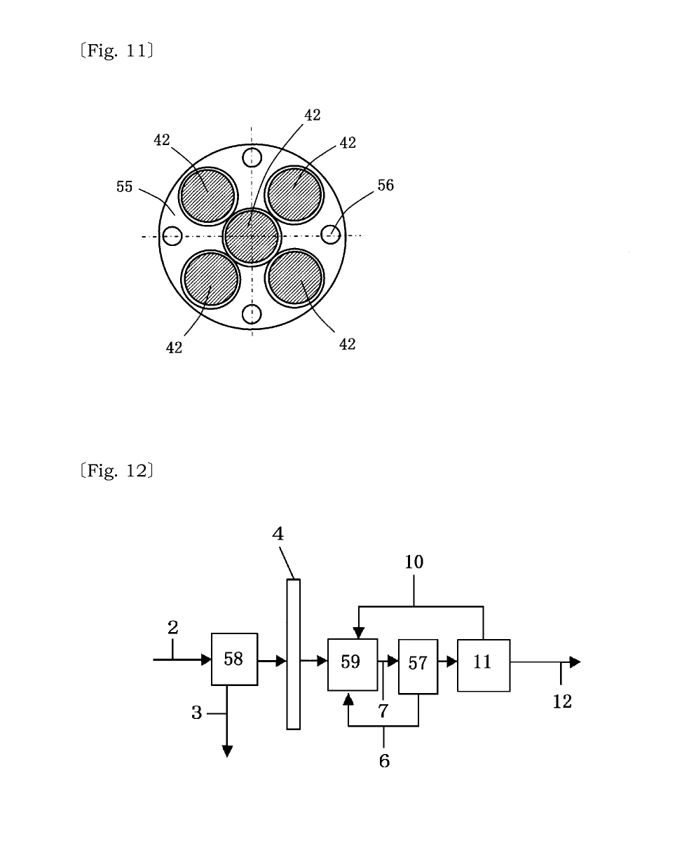

### BRIEF DESCRIPTION OF THE DRAWINGS

[FIG. 1] A block diagram which illustrates a configuration of the apparatus of the invention.

[FIG. 2] A block diagram which illustrates another configuration of the apparatus of the invention.

[FIG. 3] A block diagram which illustrates a configuration of the apparatus utilizing solar energy in the invention.

[FIG. 4] A block diagram which illustrates another configuration of the portion utilizing solar energy.

[FIG. 5] A block diagram which illustrates a solar heat collecting system of the invention.

[FIG. 6] A block diagram which illustrates another solar heat collecting system of the invention.

[FIG. 7] A block diagram which illustrates a schematic configuration of the apparatus combining the evaporation process in the invention.

[FIG. 8] A block diagram which illustrates a schematic configuration of the apparatus producing potable water from accompanied water discharged from wells.

[FIG. 9] A schematic view of a hollow fiber membrane module which is an example of the semi-permeable membrane apparatus in the apparatus of the invention, shown in side section.

[FIG. 10] A schematic view showing a longitudinal section thereof.

[FIG. 11] A schematic view illustrating a schematic configuration of a hollow fiber membrane module which is another example of the invention in longitudinal section.

[FIG. 12] A block diagram which illustrates a configuration of a conventional apparatus.

[FIG. 13] A block diagram which illustrates a configuration of another conventional apparatus.

[FIG. 14] A block diagram which illustrates a configuration of a conventional apparatus utilizing solar energy.

[FIG. 15] A block diagram which illustrates a schematic configuration of a conventional apparatus for manufacturing potable water combining the evaporation process.

[FIG. 16] A block diagram which illustrates another example of the later half portion thereof.

[FIG. 17] A side section of a conventional hollow fiber membrane module.

### MODE FOR CARRYING OUT THE INVENTION

The liquid (liquid to be treated) used for manufacturing potable water in the invention may be any one of which solvent is water, and illustrative of the liquid are seawater, lake or pond water, river water, industrial waste water, and brackish water such as accompanied water from wells, and the like.

Wells are not restricted so long as they discharge accompanied water, and examples are wells for mining shale gas, oil sand, CBM (coal bed methane), petroleum or the like.

The accompanied water is discharged together with the object to be mined from wells, and contains salt content, organic materials, suspensoids, and the like. As the concentration of contaminants, for example, evaporation residues (mainly, Na⁺, K⁺, Ca²⁺, U⁻, SO₄²⁻, and the like) is in the range of 1,000-100,000 mg/L, organic materials (oils, added agents and the like) is 10-1,000 mg/L as TOC, and suspensoids is 100-10,000 mg/L.

Separation means of accompanied water is not critical, and for example, oils are separated from water by sedimentation/floatation or the like.

### Filtration Treatment Step

In the invention, the separated accompanied water is first subjected to filtration treatment. The filtration treatment is conducted by using a microfiltration membrane filter, and the filtration membrane may conventional membrane used as microfiltration membrane. Illustrative of the membrane are membranes made of cellulose acetate, polytetrafluoroethylene, polysulfone, polyvinyl chloride or the like, and ceramic membrane, porous glass membrane and the like can also be utilized. In the microfiltration membrane treatment, membrane filtrates which passes through the microfiltration membrane and membrane concentrates which remain without passing through the membrane are obtained.

Other than microfiltration, ultrafiltration, sand filtration and the like are also applicable. The material of ultrafiltration membrane may be similar to that of microfiltration membrane.

### Forward Osmosis Step

In the forward osmosis step, the liquid to be treated is allowed to contact with the draw solution through the semi-permeable membrane, and water in the liquid to be treated is allowed to migrate to the draw solution by the difference of osmotic pressure.

The draw solution is produced by dissolving a prescribed amount of a volatile material having a boiling point of less than 100° C., and an example is aqueous ammonium carbonate salt solution produced by dissolving a prescribed amount of ammonia and carbon dioxide in water. The prescribed amount is an amount that makes a concentration capable of migrating water in the liquid to be treated up to the draw solution by passing through the semi-permeable membrane, and is higher than the salt concentration of the liquid to be treated. The upper limit of the concentration is decided so that the volatile material, for example, a salt of ammonia and carbon dioxide, i.e. ammonium carbonate, ammonium hydrogen carbonate, ammonium carbonate, does not deposit on the face of semi-permeable membrane, distillation column, and it can be determined though experimentation. A confirmation whether deposits generate on the face of semi-permeable membrane on the inside of distillation column can be done by the judgment whether a long term operation is possible stably or not. A model ratio of ammonia to carbon dioxide is about 1.5-3, and the molar ratio is considered so that a salt of ammonia and carbon dioxide does not deposit on the face of semi-permeable membrane or the inside of distillation column.

Other solutes of the draw solution applicable to the invention have a high solubility to exhibit high osmotic pressure, have a lower boiling point than, i.e. less than 100° C. and high volatility and low toxicity, and, for example, alcohols, such as ethyl alcohol, propanol and tent-butyl alcohol, ketones, such as acetone can be listed.

The semi-permeable membrane capable of permeating water selectively is suitable, and commercial products, particularly forward osmosis membrane, is preferred. The material is not particularly restricted, and for example, cellulose acetate, polyamide, polyethylene imine, polysulfone, polybenzimidazole can be listed. The shape of the semi-permeable membrane is also not restricted, and may be any of flat membrane, tubular membrane, hollow fiber or the like.

By allowing to contact the liquid to be treated with the draw solution through the semi-permeable membrane, water migrates to the draw solution by the difference of concentration.

### Distillation Step

In the distillation step. The dilute draw solution which has been diluted by the migration of water in the above forward osmosis step is optionally adjusted to a prescribed temperature, and then delivered to the distillation column, gas composed of volatile material and water vapor is taken out from the top of the column and potable water is taken out from the bottom of the column.

The prescribed temperature which is adjusted to the dilute draw solution is a temperature where a salt of volatile material dose not deposit, and it can be determined by experimentation. The temperature adjustment is, in general, performed by heating. The warming can be conducted by heat exchange with the above gas discharged from the top of the distillation column to utilize its sensible heat or latent heat, or by heat exchange with the potable water discharged from the bottom of the distillation column to utilize its sensible heat. Both can be combined, or another heat souse can be utilized.

The dilute draw solution of which temperature has been adjusted is delivered to the distillation column, and distilled there to separate volatile material, such as ammonia and carbon dioxide.

By the distillation, volatile material, such as gas composed of carbon dioxide, ammonia and water vapor is obtained from the top of the distillation column, and potable water is obtained from the bottom of the column. The potable water taken out from the bottom of the column contains, in the case that the volatile material is carbon dioxide and ammonia, carbon dioxide in a content of about 10 ppm or less and ammonia in a content of about 10 ppm or less, and by controlling the distillation conditions, potable water containing 1 ppm or less of them can be obtained.

### Cooling • Regeneration Step

In the cooling•regeneration step, gas composed of volatile material and water vapor discharged from the top of the distillation column is cooled to regenerate the draw solution, and heat exchange is used. As to the heat source for cooling, the diluted draw solution discharged from the forward osmosis membrane treatment apparatus and the like can be utilized. The regenerated draw solution is recycled to the semi-permeable membrane, and used again.

In the invention, since the draw solution in a high concentration is used, it is possible that clogging of pipers occurs by the deposition of salt. In order to prevent this, it is preferred to pass the dilute draw solution through the circulating line at regular intervals, or blow rate of the draw solution increases instantaneously.

Evaporation Step with Well Accompanied Water

In the evaporation step, the membrane concentrates obtained by the filtration of well accompanied water in the aforementioned filtration treatment step and the membrane concentrates obtained in the aforementioned forward osmosis step are concentrated by evaporation to obtain evaporation concentrates and condensed water. As the evaporator, usual evaporators, i.e. single evaporator, multi-effect evaporator, thermo-compression evaporator, multi-flash evaporator and the like can be used. The evaporator may be conducted at ordinary pressure or reduced pressure according to the heat source. It is prefunded that the heat of the condensed water is utilized as a heat source in the distillation stop by charging into the first evaporator as it is or through a heat exchanger or the like. The evaporator concentrates are delivered to the next step.

### Crystallization Step

In the crystallization step, the above evaporation condensates are further concentrated by evaporation to deposit salts contained in the evaporation condensates and while to obtain condensed water. As the crystallization apparatus, usual closed type crystallizer. The condensed water is preferably to be utilized as a heat source in the distillation step similar to the condensed water in the previous step. The slurry taken out from the crystallizer is separated into crystals and mother liquor. The crystals and mother liquor are thrown out as industrial wastes, or when they contains environmental contaminants, such as heavy metals and organic materials only little. They can be utilized as snow melting agent or the like.

The aforementioned process for manufacturing potable water is practiced by using a manufacturing apparatus of potable water comprising a forward osmosis means which allows a liquid of which solvent is water to contact with a draw solution produced by dissolving a prescribed amount of a volatile material, for example, ammonia and carbon dioxide in water though a semi-permeable membrane, and water in the above liquid is allowed to migrate to the above draw solution through the above semi-permeable membrane, a temperature adjustment means for the draw solution which adjusts the total volume of the dilute draw solution diluted with water produced in the above means to a prescribed temperature, a distillation column which distills the dilute draw solution which has been adjusted to a prescribed temperature, a cooling, regeneration means which cools the gas composed of the volatile material and water vapor obtained from the top of the above distillation column to regenerate the draw solution, and a recovery means of potable water which contains the volatile material little obtained from the bottom of the above distillation column.

### Forward Osmosis Means

In the forward osmosis means, the liquid to be treated is allowed to contact with the draw solution through the semi-permeable membrane, and water in the liquid to be treated is allowed to migrate to the draw solution through the semi-permeable membrane, and the semi-permeable membrane apparatus is used.

The semi-permeable membrane used for the semi-permeable membrane apparatus is as mentioned previously. The apparatus in which the semi-permeable membrane is attached has a configuration that the semi-permeable membrane is usually set in a cylindrical or box-shaped vessel, a-d the liquid to be treated is sun in a chamber partitioned by the semi-permeable membrane, and the draw solution is sun in to the other chamber. The semi-permeable membrane apparatus may be known one, and commercial apparatus can be used.

The inlet port of the chamber wherein the liquid to be treated suns is connected by a pipe to a reservoir of the liquid to be treated (This may be sea or river as it is, on a tank or the like.). The outlet port is, in general, connected by a pipe to a reservoir of concentrated liquid to be treated. The object liquid to be purified can be circulated can be circulated by providing a circulating line which connects both pipes.

The inlet port of the chamber wherein the draw solution suns is connected by a pipe to cooling•regeneration means, and the outlet port is connected by a pipe to the temperature adjustment means for the dilute draw solution, and thereby, a circulating line of the draw solution is formed.

In the invention, since the draw solution in a high concentration is used, it is possible that clogging of pipes occurs by deposition of salts. In order to prevent this, it is preferred to provide a means for passing the dilute draw solution at an outlet pipe of the cooling•regeneration means.

As the semi-permeable membrane means, it is preferred to use the following hollow fiber membrane module which has been developed by the inventors.

The hollow fiber membrane module is, as shown in FIGS. 9-11, bundle of many hollow fiber membrane of which both ends are opened placed in a casing.

The structure of a hollow fiber membrane module of the invention is schematically shown in FIGS. 9 and 10.

In the hollow fiber membrane module, many hollow fiber membrane 42 are arrange in order in the longitudinal direction in a cylindrical casing 41, and both ends of each hollow fiver membrane are fixed by tube sheets 43, 44. An inlet port 45 of raw water being the first fluid and an outlet port 46 of the diluted concentrate solution being the second fluid are provided at one end of the casing 41 and an outlet port 47 of the concentrated raw water and an inlet port 48 of the concentrate solution are provided on the other end. Partitions 49, 50 are disposed on the inside of both ends of the casing 41 to form chambers 51, 52. The chamber 51 on the inlet port 45 side of the raw water collects the diluted concentrate solution, and the chamber 52 on the outlet port 57 side of the concentrated raw water dispenses the concentrate solution. A chamber 53 for dispensing raw water which passed through the hollow fiber membrane 42 is provided between the tube sheet 44 on the outlet port side of the hollow fiber membrane 42 a-d the partition 50, and a chamber 54 for collecting concentrated raw water discharged from the hollow fiber membrane is provided between the tube sheet 44 on the outlet port side of the hollow fiber membrane 42 and the partition 50. Partitions 55 which inhibit passing of the second fluid are provided at three positions at almost the same intervals in the space between the outer periphery of the bundle of hollow fiber membrane 42 and the inner wall of the casing 41. Each partition 55 is provided with 4 passing openings 56 at almost the same intervals in the circumferential direction. The area of each partition occupying the space (except the passing openings 56) is 3%. In order to prevent short circuit of the second fluid, the passing openings of each partition are preferably arranged so as to be slipped to each other in the circumferential direction (dotted lines in FIG. 10).

In the hollow fiber membrane module, the raw water enters from the inlet port 45 of the raw water into the chamber 53 in the module, and passes the hollow fiber membrane 42. While water in the raw water migrates into the concentrate solution through the hollow fiver membrane by the difference of osmotic pressure. As a result, the concentrated raw water goes out the hollow fiver membrane 42, and enters the chamber 54, and goes out of the module from the outlet port 47 of the concentrated raw water. The concentrate solution enters the chamber 52 in the module from the inlet port 48 of the concentrate solution, passes the partition 50, and flows on the outside of the hollow fiber membrane 42. While, the concentrate solution flowing the space between the inner wall of casing and the outer periphery of the bundle of hollow fiber membranes hits the partition 55, and changes the flow direction toward the inside of the bundle of hollow fiber membranes, whereas, a part passes the passing opening 56. Thus, mixing occurs well in the module, and the concentration in the vicinity of membrane surface comes to close to the concentration of the main flow, and water in the raw water is allowed to migrate into the concentrate solution efficiently. The concentrate solution diluted with the water migrated from the raw water is collected to the chamber 51, and discharged from the outlet port 46 of the diluted concentrate solution.

FIG. 11 shows a schematic structure of another follow fiber membrane module of the invention in longitudinal section. 5 bundles of respective many follow fiber membranes 42 are placed in a casing, and partitions 55 are provided for inhibiting short circuit of the second fluid in the space between the inner wall of casing and the bundles of hollow fiber membranes and the space between the bundles of hollow fiber membranes.

The hollow fiber membrane may be commercial products, and the material is not restricted, and selected from cellulose, cellulose esters, such as cellulose acetate, cellulose ether, polyamide, silicone resin, polyester resin, unsaturated polyester resin, ceramics or the like, which can pass the object material selectively. The shape of the hollow fiber membrane is also not restricted, and examples are circle, hexagon, trilobal in section. The number of hollow fibers depends on the size of the casing which places the hollow fiber membranes, and for example, about 1,000 to 1,000,000 fibers for the casing 8 inches in diameter.

The number of the bundles of the hollow fiber membranes may be one or plural, for example, 3, 6 or 7 bundles.

The both ends of the hollow fiber membrane are opened, and the both ends are fixed by tube sheets.

In the case of reverse osmosis, the casing for placing the bundle of hollow fiber membranes must be a pressure vessel capable of resisting the pressure. In the case of forward osmosis, it is not necessary to be a pressure vessel. The shape of the casing is not restricted bat is usually cylindrical.

The casing is provided with an inlet port of the first fluid passing the inside of hollow fiber membrane and an outlet port of the second fluid passing the outside of hollow fiber membrane at are end, and an outlet port of the first fluid and an inlet port of the second fluid at the other end. Those ports may be formed on the end face of the casing or end of body portion. Partitions are provided so as not to mix the first fluid and the second fluid.

Hollow fiber modules are, in general, provided with space between the outer periphery of the bundle of hollow fiber membranes and the inner wall of the casing in order to ensure the flow of the second fluid.

The hollow fiber membrane module of the invention is characterized by providing partitions which inhibits short circuit of the second fluid in the space. The partitions stops the flow of the second fluid flowing the space between the inner wall of the casing and the bundle of hollow fiber membrane, and the flow is turned toward the inside of the bundle of hollow fiber membranes. The area of the partition (The area in the cross direction at right angle to the longitudinal direction of the casing) is preferably about 95% or less of the area of the space, because, when the partition cuts the whole space, the flow of the second fluid is degraded. The shape is not restricted, and for example, ring-shaped. When the number of the bundles of hollow fiber membranes is plural, it is rendered in a lotus root shaped. The partition can be provided with passing opening. The passing opening renders the flow of the second fluid close to uniform, and thereby, deed spaces are removed. The shape is not restricted, but circle is preferred in view of low pressure loss and rare clogging. The diameter is, for example, about 5-20 mm. A suitable number of partitions is 1 partition per 10-100 cm of the longitudinal length of the casing.

The hollow fiber membrane module of the invention can be used for both of the forward osmosis and the reverse osmosis, and displays its power for the forward osmosis which uses the difference of osmotic pressure as a driving force for filtration. Either of the raw water or the concentrate solution can be made or the first fluid.

The type of the liquid to be treated by the hollow fiber membrane module is also not restricted, and is applicable, for example, to the manufacture of potable water from seawater, the purification of waste water, the manufacture of sterile water, and the like.

### Temperature Adjustment Means for Dilute Draw Solution

In the temperature adjustment means for the dilute draw solution, the draw solution diluted by the extraction of water from the liquid to be treated in the semi-permeable membrane apparatus is adjusted to a prescribed temperature in order to deliver it into the distillation column. The prescribed temperature is a temperature where the salt of ammonia and carbon dioxide dose not deposit, and can be determined by experimentation. The temperature adjustment is conducted, in general, by heating. The heating can be performed by the heat exchange with the aforementioned gas discharged from the top of the distillation column to utilize its sensible heat or latent heat, or by the heat exchange with potable water discharged from the bottom of the distillation column to utilize its sensible heat. Both can be combined, or another heat source can also be utilized.

The temperature adjustment means for the dilute draw solution is connected to the distillation column by pipes.

### Distillation Column

The distillation column may be a known one, and may be either a tray type or a packed type or the like. A heater is disposed at the underside of the distillation column, and steam is generated by heating the notable water existing at the underside. The steam is allowed to contact with the dilute draw solution fallen from the upside to conduct heat exchange. A reboiler, heat exchanger or the like can be used as the heater. The heat source of the heater is not restricted, and may be the steam discharged from the turbine before condensation or hot water recovered from exhaust heat in a power station, or the like. When the temperature of heat source is 100° C. or higher, distillation can be conducted at ordinary pressure. In the case of lower than that, pressure reduction is necessary.

Solar heat can be utilized as the heat source of the heater. Actually, water is heated directly by a sunlight condenser to generate steam, or by providing a sunlight condenser and a steam generator, heating medium is heated in the sunlight condenser, and the heating medium is heat-exchanged with water in the steam generator to generate steam.

In every case, the sunlight condenser may a common one used for the utilization of solar energy. In general, heating pipe is disposed at focal point of a concave mirror or a trough-shaped reflecting mirror, a group of reflecting mirrors which traces automatically the position of the sun at several second intervals, called heliostat.

The heating medium may also be a common one used for the utilization of solar energy, such as heating medium oil, e.g. silicone oil, molten salt which flows like water in the molten state, such as lithium carbonate and potassium carbonate.

In the case that the heating source of the heater is only solar energy, it is desirable to provide a heat accumulator in order to ensure stable heat supply, or heat supply may be stabilized by providing an auxiliary heater.

In the invention, a potable water-manufacturing apparatus by the evaporation process is combined, and the sensible heat of the potable waiter obtained by the apparatus by the evaporation process can be utilized for the heat source of the distillation apparatus. The utilization may be an indirect method by the heat exchange with the dilute draw solution by a heat exchanger, or a direct method by introducing the potable water into the distillation column. By this, the sensible heat of the potable water by the evaporation process wasted in the past can be utilized effectively. On that occasion, other heat source can be combined at reed. The type of the other heat source is not restricted, and steam discharged from the turbine before condensation, hot water recovered from the exhaust heat in a power station can be used.

By the distillation, gas composed of volatile material and water vapor is obtained from the top of the distillation column, and potable water is obtained from the bottom of the column. The potable water taken out from the bottom of the column has, in the case that the volatile material is carbon dioxide and ammonia, content of carbon dioxide of about 10 ppm or less and a content of ammonia of about 10 ppm or less, and the potable water containing 1 ppm or less of them by controlling the distillation conditions.

### Cooling • Regeneration Means

The top of the distillation column is connected to the cooling • regeneration means for the top of the column gas through the temperature adjustment means for the dilute draw solution by pipes, and gas composed of volatile material and water obtained how the top of the column is cooled to render aqueous solution state. The cooling means is not restricted, and a heat exchanger can be used. The heat source for cooling is also not restricted, river water, seawater, air and the like can be used.

### Reservoir Tank of Draw Solution

The reservoir tank of the draw solution is a receiver of the draw solution regenerated in the cooling • regeneration means, and may be combined with a tank of the draw solution previously prepared.

### Recovery Means for Potable Water

The recovery means for the potable water is a means to draw potable water containing volatile material little accumulated in the bottom of the distillation column is extracted from there, and a pump is commonly used therefor. In the case that there is a considerable difference in level between the distillation column and the reservoir tank of potable water, and the pressure in the inside of the distillation column is not reduced, natural flowing out can be utilized. When the potable water extracted from the bottom of the column contains a small amount of volatile material, such as ammonia and carbon dioxide, it is suitably heated according to its use.

### Reservoir Tank of Potable Water

The reservoir tank of potable water is a reservoir of the potable water extracted from the bottom of the distillation column.

A configuration of an apparatus for manufacturing potable water to which the invention is applied is shown in FIG. 1.

In FIG. 1, 1 is a semi-permeable membrane apparatus, wherein semi-permeable membrane 4 is placed. The seawater 2 which is an example of the liquid of which solvent is water enters the chamber on the left side of the vessel, and water 5 is allowed to migrate into the chamber on the right side through the semi-permeable membrane by the difference of osmotic pressure from the draw solution there. The concentrated seawater 3 thereby is discharged from the chamber on the left side. The draw solution 6 enters the chamber on the right side, and the dilute draw solution 7 diluted with the water passed through the semi-permeable membrane 4 goes out from the chamber on the right side.

The dilute draw solution 7 gone out of the chamber is warmed by the heat exchange in the heat exchanger 16, and enters the distillation column 11.

In the distillation column 11, the dilute draw solution 7 is distilled, and gas composed of volatile material and water vapor is discharged from the top of the column. The gas is cooled by the heat exchange in the above heat exchanger 16, and returned to the draw solution 6 by the further heat exchange with cooling water in the next heat exchanger 17. The draw solution 6 is recycled to the inside of the semi-permeable membrane apparatus 1 of the semi-permeable membrane 4 through a pump 18.

On the other hand, potable water 12 substantially not containing volatile material is discharged from the bottom of the column. The potable water 12 is heat exchanged with cooling water is the heat exchanger 20, and taken out of the system.

Another example of the potable water-manufacturing apparatus of the invention is shown in FIG. 2. The apparatus is the same as that of FIG. 1, except that a further heat exchanger 21 is provided, and the dilute draw solution 7 discharged from the heat exchanger 16 is further heat exchange with the potable water discharged from the heat exchanger 20.

Another example of the potable water-manufacturing apparatus of the invention is shown in FIG. 3. This apparatus is, in the apparatus of FIG. 1, a reboiler 15 is provided at the lower portion of the distillation column 11, and sunlight is collected by a sunlight condenser 13 to heat the water is a heating pipe (not illustrated.). The water becomes steam in the steam generator 14, and delivered to the reboiler 15 in the distillation column 11.

FIG. 4 illustrates an example where heating medium is heated by a sunlight condenser 13, and is delivered to a heat collector 19 to heat the water existing therein, and the water is made steam in the steam generator 14.

Another example of the potable water-manufacturing apparatus is shown in FIG. 7.

The apparatus is composed of a feeder 24 of the water to be treated, an evaporation process potable water-manufacturing apparatus 22, a FO module (a forward osmosis process potable water-manufacturing apparatus) 1, a draw solution reservoir 23 and a distillation apparatus 11.

The water to be treated 2 is delivered by the feeder 24 of the water to be treated to the evaporation process potable water-manufacturing apparatus 22 and the forward osmosis potable water-manufacturing apparatus 1, and concentrated water to be treated 3 and potable water 12 are discharged from the evaporation process potable water-manufacturing apparatus 22.

From the forward osmosis potable water-manufacturing apparatus 1, concentrated water to be treated 3 is discharged which does not pass the membrane. On the other hand, the draw solution 6 is delivered from the draw solution reservoir 23 to the opposite side chamber partitioned by the membrane, and is diluted with water passed through the membrane, and goes out of the chamber. The dilute draw solution 7 gone out of the chamber is returned to the draw solution reservoir 23 to from a circulating line.

A part of the draw solution reserved in the draw solution reservoir 23 is delivered to the distillation apparatus 11, and evaporated volatile material and water is returned to the draw solution reservoir 23 where they are dissolved. To the distillation apparatus 11, a feed line of potable water is connected also from the evaporation process potable water-manufacturing apparatus 22, and heat exchange is conducted directly or indirectly. The heat is used in the distillation apparatus 11. Water from which volatile material has been removed by distillation, is finally extracted as potable water 12.

In the following examples and comparative examples, numerical values were calculated by using a chemical engineering simulator PRO/II ver 9.0.1 and the Electrolytes which is one of PRO/II module and can simulate deposition of solid ammonium carbonate sold by System Company.

### Example 1

The draw solution containing 8.5 mol/L ammonia and 5.6 mol/L carbon dioxide was used. All of the remainder was water, and a molar ratio of ammonia to carbon dioxide is 1.5.

The inflow rate at the inlet port of the draw solution of the semi-permeable membrane apparatus was set 200 kg/hr. An aqueous sodium chloride solution which simulated seawater was used as the liquid to be treated. The volume of water which passed the separation apparatus which simulated the semi-permeable membrane to migrate into the draw solution was 1,000 kg/hr., and the volume of the dilute draw solution discharged from the outlet port of the draw solution was 1,200 kg/hr., and its temperature was 28° C.

The dilute draw solution was heated to 38° C. by the heat exchange with the gas discharged from the top of the distillation column, and delivered into the first stage at the upper portion of the distillation column.

The distillation column was a tray tower type with 30 stages, and a reboiler was mounted at the lower most 30^{th} stage. The temperature at the 30^{th} stage was set 46° C., and the inside pressure of the distillation column was set in reduced pressure conditions at 10 kPa (A represents absolute pressure.).

The potable water which was discharged from the bottom of the distillation column, contained less than 1 ppm of carbon dioxide and ammonia.

The gas which was discharged from the top of the distillation column, had a temperature of 39° C. and a molar ratio of 0.68 of water, 0.13 of carbon dioxide and 0.19 of ammonia.

The gas was cooled to 29° C. by subjecting to the heat exchange with the dilute draw solution discharged from the separation apparatus which simulated the semi-permeable membrane, and further the heat exchange with seawater at 25° C. to render it in an aqueous solution state, and returned to the separation apparatus which simulated the semi-permeable membrane.

### Example 2

The draw solution containing 6.9 mol/L ammonia and 3.1 mol/L carbon dioxide was used. All of the remainder was water, and a molar ratio of ammonia to carbon dioxide is 2.2. The inside pressure of the distillation column was 59 kPa A.

The inflow rate at the inlet port of the draw solution of the separation apparatus which simulated the semi-permeable membrane apparatus was set 0.42 kg/hr. An aqueous sodium chloride solution which simulated seawater was used as the liquid to be treated. The volume of water which passed the separation apparatus which simulated the semi-permeable membrane to migrate into the draw solution was 2.52 kg/hr., and the volume of the dilute draw solution discharged from the outlet port of the draw solution was 2.94 kg/hr., and its temperature was 29° C.

The dilute draw solution was heated to 59° C. by the heat exchange with the gas discharged from the top of the distillation column, and delivered into the first stage at the upper portion of the distillation column.

The gas which was discharged from the top of the distillation column, had a temperature of 80° C. and a molar ratio of 0.780 of water, 0.068 of carbon dioxide and 0.152 of ammonia.

The gas was cooled to 60° C. by subjecting to the heat exchange with the dilute draw solution discharged from the separation apparatus which simulated the semi-permeable membrane, and further the heat exchange with seawater at 25° C. to render it in an aqueous solution state, and returned to the separation apparatus which simulated the semi-permeable membrane.

### Example 3

The draw solution containing 6.8 mol/L ammonia and 4.0 mol/L carbon dioxide was used. All of the remainder was water, and a molar ratio of ammonia to carbon dioxide is 1.7. The inside pressure of the distillation column was atmospheric pressure.

The inflow rate at the inlet port of the draw solution of the separation apparatus which simulated the semi-permeable membrane apparatus was set 250 kg/hr. An aqueous sodium chloride solution which simulated seawater was used as the liquid to be treated. The volume of water which passed the separation apparatus which simulated the semi-permeable membrane to migrate into the draw solution was 1,000 kg/hr., and the volume of the dilute draw solution discharged from the outlet port of the draw solution was 1.25 kg/hr., and its temperature was 40° C.

The dilute draw solution was heated to 92° C. by the heat exchange with the gas discharged from the top of the distillation column, and delivered into the first stage at the upper portion of the distillation column.

The heating quantity of the reboiler existing at the under portion of the column was 270 MJ/hr. at this time, and the volume of potable water from the under portion of the column was 1,000 kg/hr.

The gas which was discharged from the top of the distillation column, had a temperature of 93° C. and a molar ratio of 0.755 of water, 0.091 of carbon dioxide and 0.154 of ammonia.

The gas was cooled to 62° C. or less by subjecting to the heat exchange with the dilute draw solution discharged from the separation apparatus which simulated the semi-permeable membrane, and further the heat exchange with seawater at 25° C. to render it in an aqueous solution state, and returned to the separation apparatus which simulated the semi-permeable membrane.

### Comparative Example 1

A comparison of energy with Example 3 was conducted.

The flow in this comparative example was the configuration of the apparatus shown in FIG. 3. The draw solution in the vessel for mixing the aqueous solution and the gas contained 4.3 mol/L ammonia and 2.5 mol/L carbon dioxide, and the remainder was water. The inside pressure of the distillation column was atmospheric pressure.

The inflow rate at the inlet port of the draw solution of the separation apparatus which simulated the semi-permeable membrane apparatus was 630 kg/hr which was required the volume of water which passed the semi-permeable membrane to migrate into the draw solution to render 1,800 kg/hr.

1630 kg/hr in total of the diluted draw solution is returned to the vessel for mixing the aqueous solution and the gas.

While, the draw solution withdrawn from the vessel for mixing the aqueous solution and the gas was heated to 85° C. by the heat exchange with the gas discharged from the top of the distillation column, and delivered to the first stage at the upper portion of the distillation column.

The heat input at the reboiler portion was 430 MJ/hr which was required the volume of potable water from the underside of the column to render 1,000 kg/hr.

The gas which was discharged from the top of the distillation column, had a temperature of 86° C. and a molar ratio of 0.556 of water, 0.164 of carbon dioxide and 0.279 of ammonia. This gas is returned to the vessel for mixing the aqueous solution and the gas.

The heat input at the reboiler necessary for the manufacture of 1,000 kg/hr of potable water is shown in Table 1. Compared with the conventional process, required heat quantity at the reboiler portion can be decreased by about 40%.

TABLE 1

| | |
|---|---|
| Example 3 | 270 MJ/hr |
| Comparative Example 1 | 430 MJ/hr |

In addition, the volume of the draw solution passing through the semi-permeable membrane is shown in Table 2. Since the volume of the draw solution necessary for drawing the same volume of water through the semi-permeable membrane can be decreased by 50% or more, the power of pump can be saved sharply.

TABLE 2

| | |
|---|---|
| Example 3 | 250 kg/hr |
| Comparative Example 1 | 630 kg/hr |

### Example 4

As the draw solution, an aqueous solution containing ammonium carbonate was used which contained 8.5 mol/L ammonia and 5.6 mol/L carbon dioxide. All of the remainder was water, and the inflow rate at the inlet port of the draw solution of the semi-permeable membrane apparatus was set 20 kg/hr. Using an artificial seawater containing 35,000 mg/L of sodium chloride as the liquid to be treated, the inflow rate at the inlet port was set 200 kg/hr. The volume of water which passed the semi-permeable membrane to migrate into the draw solution was 100 kg/hr, and the volume of the dilute draw solution discharged from the outlet port of the draw solution was 120 kg/hr, and its temperature was 28° C.

The dilute draw solution was heated to 38° C. by the heat exchange with the gas discharged from the top of the distillation column, and charged into the first stage at the upper portion of the distillation column.

The distillation column was a tray tower type with 30 stages, and a reboiler was mounted at the lowermost 30th stage. The temperature at the 30^{th} stage was set 100° C., and the inside pressure of the distillation column was set atmospheric conditions.

Solar heat was collected, and the generated steam was used as heat source for the reboiler. Using a concave mirror having a sectional form of the mirror face in the axial direction being parabolic for the sunlight condenser, water was supplied to the inside of heating pipe located at the focal point to generate 20 kg/hr of saturated steam at 120° C. by the heat exchange of water with the condensed solar heat energy. The effective mirror area of the condenser used for the condensation of solar heat was 17.5 m². The solar heat collecting system employed in this example is shown in FIG. 5.

Under the conditions, potable water discharged from the bottom of the distillation column was at a rate of 100 kg/hr, and the concentration of carbon dioxide and ammonia contained in the potable water was 1 ppm or less.

The gas which was discharged from the top of the distillation column, had a temperature of 39° C. and a molar ratio of 0.68 of water, 0.13 of carbon dioxide and 0.19 of ammonia.

The gas was cooled to 29° C. by the heat exchange with the dilute draw solution discharged from the semi-permeable membrane apparatus and further the heat exchange with seawater at 25° C. to render it in an aqueous solution state, and returned to the semi-permeable membrane apparatus.

### Example 5

As the draw solution, an aqueous solution containing ammonium carbonate was used which contained 8.5 mol/L ammonia and 5.6 mol/L carbon dioxide. All of the remainder was water, and the inflow rate at the inlet port of the draw solution of the semi-permeable membrane apparatus was set 20 kg/hr. Using an antificial seawater containing 35,000 mg/L of sodium chloride as the liquid to be treated, the inflow rate at the inlet port was set 200 kg/hr. The volume of water which passed the semi-permeable membrane to migrate into the draw solution was 100 kg/hr, and the volume of the dilute draw solution discharged from the outlet port of the draw solution was 120 kg/hr, and its temperature was 28° C.

The dilute draw solution was heated to 38° C. by the heat exchange with the gas discharged from the top of the distillation column, and charged into the first stage at the upper portion of the distillation column.

The distillation column was a tray tower type with 30 stages, and a reboiler was mounted at the lowermost 30th stage. The temperature at the 30th stage was set 100° C., and the inside pressure of the distillation column was set atmospheric conditions.

Solar heat was collected, and the generated steam was used as heat source for the reboiler. Using a concave mirror having a sectional form of the mirror face in the axial direction being parabolic for the sunlight condenser, a heating medium oil was supplied to the inside of heating pipe located at the focal point. The heating medium oil used was a fluorine-based heating medium oil having a boiling point of 350° C. The heating medium supplied into the heating pipe was heat-exchanged with solar heat through the heating pipe, while flowing therein, and heated to 130° C. at the outlet port of the sunlight condenser, and stored in a heat collecting apparatus. 20 kg/hr of saturated steam at 120° C. was generated by running the stored heating medium oil in a steam generator wherein heat-exchanged with water. In this example, solar energy was collected by a sunlight condenser having an effective mirror area of 100 m², in order to ensure stable generation of steam in the right after setting the sun by the heat accumulated in the daytime. The solar heat collecting system used in this example is shown in FIG. 6.

Under the conditions, potable water discharged from the bottom of the distillation column was at a rate of 100 kg/hr, and the concentration of carbon dioxide and ammonia contained in the potable water was 1 ppm or less.

The gas which was discharged from the top of the distillation column, had a temperature of 39° C. and a molar ratio of 0.68 of water, 0.13 of carbon dioxide and 0.19 of ammonia.

The gas was cooled to 29° C. by the heat exchange with the dilute draw solution discharged from the semi-permeable membrane apparatus and further the heat exchange with seawater at 25° C. to render it in an aqueous solution state, and returned to the semi-permeable membrane apparatus.

### Example 6

An example of the invention will be explained with reference to FIG. 8. In the apparatus of FIG. 8, a reaction vessel, a MF membrane (microfiltration membrane apparatus), a FO membrane (forward osmosis membrane treatment apparatus), an evapolator (first evaporation apparatus), an evaporation apparatus (second evaporation apparatus) and a crystallization apparatus are arranged in this order.

1,000 m³/d of accompanied water separated from crude oil taken out from operating wells was introduced into the reaction vessel, and a dispersing agent is added there to inhibit deposition of Ca²⁺. Then, it is delivered to the MF membrane, and solid matter contained in the accompanied water is removed as membrane concentrates. The membrane filtrates which have passed the membrane is delivered to the FO membrane. The membrane filtrate is allowed to contact with the draw solution through the membrane there, and water contained in the membrane filtrate passes the membrane to dilute the draw solution. The dilute draw solution enters the evaporator where the pressure is reduced to 10 kPa, and heated there to evaporate gas composed of carbon dioxide, ammonia and water vapor at the boiling point of 45° C. The heat quantity necessary for the evaporation is 250 GJ/d. The gas is cooled by passing a heat exchanger to return to the draw solution, and returned to the FO membrane. At this time, it is preferred that the accompanied water or MF filtrate is used as the cooling water, because membrane filtration rate is increased by the decrease of viscosity caused by warming the object water to be treated. The potable water at 45° C. remaining in the evaporator is taken out at a rate of 1,000 m³/d, and after adding an agent, it is reutilized as the water for mining.

The membrane concentrates concentrated by the withdrawal of water passing through the forward osmosis membrane is delivered to the evaporation apparatus at a rate of 500 m³/d. The inside pressure of the evaporator is reduced to 39 kPa by a vacuum pump, and a circulating line by a heat pump is formed to heat by steam in the midway, and thereby, the inside can be heated. Condensed water at 75° C. is separated in the evaporation apparatus, and taken out at a rate of 250 m³/d.

The evaporation concentrates accumulated in the bottom of the evaporation apparatus is taken out by a pump, and a part is returned to the evaporation apparatus by spraying from the top toward the inside. A part is delivered to the crystallization apparatus at a rate of 250 m³/d as the evaporation concentrates. The crystallization apparatus is provided with a heating mechanism configured by extracting by a pump, heating by a heater and returning, and the inside evaporation concentrates can be further concentrated by evaporation. Crystals of salts deposited by the concentration are taken out from the bottom of the crystallization apparatus. Evaporated condensates are taken out at a rate of 250 m³/d, and heated to 75° C. by a heater. It is combined with the condensates at a rate of 250 m³/d from the evaporation apparatus, and the condensates at 75° C. is delivered to the evaporator at a rate of 500 m³/d (63 GJ/d) to utilize its heat. The short heat quantity (187 GJ/d) is further added to the evaporator in a form of steam.

The steam saving effect by utilizing the heat quantity of the condensates which is to be waste heat is as follows:

TABLE 3
Total cost for manufacturing water (yen/m³)

| Scale (m³/day) | RO | FO | FO (utilizing waste heat) |
|---|---|---|---|
| 1,000 | 1,000 | 1,000 | 940 |
| 3,000 | 900 | 880 | 820 |

Saving of steam by the utilization of waste heat is 25%.

### INDUSTRIAL APPLICABILITY

According to the invention, since potable water can be manufactured from the liquid to be treated such as seawater stably and surely, the invention can be applied widely to a process and an apparatus for manufacturing potable water from seawater or the like. In addition, since the accompanied water discharged together with crude oil or the like from wells, such as oil wells can be treated to reutilize it, the invention can be utilized widely for wells in every place.

### DESCRIPTION OF REFERENCE SIGNS

1 Semi-permeable membrane apparatus
2 Seawater, water to be treated
3 Concentrated seawater, concentrated water to be treated, membrane concentrate
4 Semi-permeable membrane
5 Water which migrates by passing semi-permeable membrane
6 Draw solution
7 Dilute draw solution
8 Mixing vessel of aqueous solution and gas
9 Aqueous solution containing mixed carbon dioxide and ammonia
10 Gas composed of carbon dioxide, ammonia and water discharged from the top of distillation column
11 Distillation column
12 Potable water
13 Sunlight condenser
14 Steam generator
15 Reboiler
16 Heat exchanger (temperature adjustment means for dilute draw solution)
17 Heat exchanger
18 Pump
19 Heat collector
20 Heat exchanger
21 Heat exchanger
22 Evaporation process potable water-manufacturing apparatus
23 Draw solution reservoir
24 Feeder of water to be treated
41 Casing
42 Hollow fiber membrane
43 Tule sheet
44 Tule sheet
45 Raw water (first fluid) inlet port
46 Diluted concentrate solution outlet port
47 Outlet port of concentrated raw water
48 Concentrate solution (second fluid) inlet port
49 Partition
50 Partition
51 Chamber
52 Chamber
53 Chamber
54 Chamber
55 Partition
56 Passing opening
57 Third chamber
58 First chamber
59 Second chamber

1. A process for manufacturing potable water which comprises:
a forward osmosis step wherein a liquid of which solvent is water is allowed to contact with a draw solution produced by dissolving a prescribed amount of a volatile material in water through a semi-permeable membrane, and water in said liquid is allowed to migrate to said draw solution through said semi-permeable membrane;
a distillation step wherein a dilute draw solution having been diluted with water which was produced in said step is adjusted to a prescribed temperature, and then is delivered to a distillation column where gas comprising the volatile material and water vapor is discharged from the top of the column and potable water is discharged from the bottom of the column; and
a cooling • regeneration step wherein said draw solution is regenerated by cooling said gas.

2. The process for manufacturing potable water as set forth in claim 1, wherein the volatile material is ammonia and carbon dioxide.

3. The process for manufacturing potable water as set forth in claim 1, wherein the temperature of said dilute draw solution delivered to the distillation column is adjusted by the heat exchange with said gas.

4. The process for manufacturing potable water as set forth in claim 3, wherein the temperature of said dilute draw solution delivered to the distillation column is adjusted further by the heat exchange with said potable water.

5. The process for manufacturing potable water as set forth in claim 1, wherein steam manufactured by utilizing condensed solar energy is used as a heating source of the dilute draw solution in said distillation step.

6. The process for manufacturing potable water as set forth in claim 5, wherein said steam is the steam manufactured by utilizing a heating medium heated by condensed solar energy.

7. The process for manufacturing potable water as set forth in claim 1, which further comprises an evaporation process potable water-manufacturing apparatus, and the sensible heat of the potable water manufactured by said evaporation process potable water-manufacturing apparatus is utilized as the heating source for the dilute draw solution in the distillation step.

8. The process for manufacturing potable water as set forth in claim 7, wherein the sensible heat of said potable water is transferred to said dilute draw solution through a heat exchanger.

9. The process for manufacturing potable water as set forth in claim 7, wherein said potable water is introduced into said dilute draw solution directly.

10. The process for manufacturing potable water as set forth in claim 1, wherein said liquid is seawater.

11. The process for manufacturing potable water as set forth in claim 1, wherein the dilute draw solution is fed periodically to the pipe where said draw solution flows, or the flow rate of said draw solution increases instantaneously.

12. The process for manufacturing potable water as set forth in claim 1, wherein said liquid of which solvent is water is filtrate of accompanied water discharged from wells filtered in a filtration treatment step, and further comprises an evaporation step where membrane concentrates which are left by passing water in said liquid through the membrane to migrate into the draw solution, are concentrated by evaporation to obtain evaporation concentrates and condensed water, and a crystallization step where said evaporation concentrates are further concentrated by evaporation to deposit salts contained in said evaporation concentrates and to obtain condensed water.

13. The process for manufacturing potable water as set forth in claim 12, wherein at least one of the condensed water obtained in said evaporation step or the condensed water obtained said crystallization step is used as a heating source of the dilute draw solution in said distillation step.

14. The process for manufacturing potable water as set forth in claim 13, wherein at least one of the condensed water obtained in said evaporation step or the condensed water obtained said crystallization step is directly introduced as a heating source of the dilute draw solution in said distillation step.

15. The process for manufacturing potable water as set forth in claim 12, wherein said potable water is reutilized as water or steam for mining said wells.

16. An apparatus for manufacturing potable water which comprises:
a forward osmosis means wherein a liquid of which solvent is water is allowed to contact with a draw solution produced by dissolving a prescribed amount of a volatile material in water through a semi-permeable membrane, and water in said liquid is allowed to migrate to said draw solution through said semi-permeable membrane;
a means for adjusting the temperature of a dilute draw solution, wherein the total volume of the dilute draw solution diluted with water produced in said means is adjusted to a prescribed temperature, a distillation column which distills the dilute draw solution adjusted to the prescribed temperature in said means for adjusting the temperature, a cooling•regeneration means for cooling the gas comprising the volatile material and water vapor obtained from the top of said distillation column to regenerate the draw solution, and a means for recovering potable water containing volatile material little obtained from the bottom of said distillation column.

17. The apparatus for manufacturing potable water as set forth in claim 16, wherein the volatile material is ammonia and carbon dioxide.

18. The apparatus for manufacturing potable water as set forth in claim 16, wherein said means for adjusting the temperature of a dilute draw solution is a heat exchanger of said dilute draw solution and said top of the column gas.

19. The apparatus for manufacturing potable water as set forth in claim 18, wherein said means for adjusting the temperature of a dilute draw solution further comprises a heat exchanger of said dilute draw solution and said potable water.

20. The apparatus for manufacturing potable water as set forth in claim 16, wherein said semi-permeable membrane is hollow fiber membrane, and the semi-permeable membrane apparatus equipped with it is a hollow fiber membrane module containing a bundle of a number of hollow fiber membranes of which both ends are opened in a casing, the casing has an inlet port of a first fluid flowing on the inside of the above hollow fiber membrane and an outlet port of a second fluid flowing on the outside of the hollow fiber membrane at one end of the casing, and an outlet port of the first fluid flowing on the inside of the hollow fiber membrane and an inlet port of the second fluid flowing on the outside of the hollow fiber membrane at the other end of the casing, and the module has partitions which inhibit short circuit of the second fluid in the space between the inner wall of the casing and the outer periphery of the bundle of the hollow fiber membranes.

21. The apparatus for manufacturing potable water as set forth in claim 20, wherein plural bundles of said bundle of a number of hollow fiber membranes are contained in the casing, and said partitions inhibit passing of said second fluid through between the inner wall of said casing and outer periphery of said bundles of hollow fiber membranes and between the bundles of hollow fiber membranes.

22. The apparatus for manufacturing potable water as set forth in claim 20, wherein said partitions are provided with passing openings of said second fluid.

23. The apparatus for manufacturing potable water as set forth in claim 16, wherein a steam generator which generates steam by utilizing solar energy collected by a sunlight collector as a heating means for the dilute draw solution in said distillation column.

24. The apparatus for manufacturing potable water as set forth in claim 16, wherein a heat collecting apparatus which stores heating medium heated by the solar energy collected by a sunlight collecting apparatus, and a steam generator which generates steam by utilizing the heating medium stored in said heat collecting apparatus.

25. The apparatus for manufacturing potable water as set forth in claim 16, which further comprises an evaporation process potable water-manufacturing apparatus, and a heat transferring means for transferring the sensible heat of potable water manufactured in said evaporation process potable water-manufacturing apparatus to the dilute draw solution distilled in said distillation column as a heating means for the dilute draw solution in said distillation column.

26. The apparatus for manufacturing potable water as set forth in claim 25, wherein said heat transferring means is a heat exchanger of said potable water and said dilute draw solution.

27. The apparatus for manufacturing potable water as set forth in claim 25, wherein said heat transferring means is a means for mixing said potable water and said dilute draw solution directly.

28. The apparatus for manufacturing potable water as set forth in claim 16, wherein said liquid is seawater.

29. The apparatus for manufacturing potable water as set forth in claim 16, wherein the outlet port pipe of said cooling • regeneration means is provided with a means for introducing a dilute draw solution.

30. The apparatus for manufacturing potable water as set forth in claim 16, wherein the liquid of which solvent is water is a filtrate obtained by the filtration treatment of accompanied water discharged from wells by a filtration apparatus, and further comprises an evaporation apparatus which concentrates the membrane concentrates left by passing water in said liquid through the semi-permeable membrane into the draw solution in said forward osmosis treatment apparatus by evaporation, to obtain evaporation concentrates and condensed water, and a crystallization apparatus which further concentrates said evaporation concentrates by evaporation to deposit salts contained in said evaporation concentrates and condensed water.

31. The apparatus for manufacturing potable water as set forth in claim 30, which further comprises a means for introducing directly at least one of condensed water obtained in said evaporation apparatus or condensed water obtained in said crystallization apparatus as a heating source of the dilute draw solution in said distillation column.
